(19) United States
(12) Patent Application Publication
(10) Pub. No.: US 2014/0123047 A1
(43) Pub. Date: May 1, 2014

(54) Computer System for Displaying Indicators on a Map

(71) Applicant: Cristiano SOLARINO, East Sussex (GB)

(72) Inventor: Cristiano SOLARINO, East Sussex (GB)

(21) Appl. No.: 13/660,594

(22) Filed: Oct. 25, 2012

(51) Int. Cl. G06F 3/048

(52) U.S. Cl. 715/772

(57) ABSTRACT

A computer system is disclosed in which a touch-screen display (10) displays a map to a user. The user can select a location on the map and an indicator (50) is displayed on the map at the selected location. A server processor (18) is provided to modify a first aspect of the appearance of the indicator (50) in dependence on the time that has elapsed since the location on the map was selected. A reinforcement tool is also provided so that a user can endorse an indicator (50), and the server processor (18) can modify an aspect of the appearance of the indicator in dependence on the number of endorsements received. A GPS receiver (12) is also provided so that the user device (2) can generate an alert when the position determined by the positioning device is within a predetermined range of a location of interest.

This invention relates to a computer system and a corresponding method for displaying indicators on a map.

### BACKGROUND OF THE INVENTION

The advent of GPS-enabled cellular phones has triggered a rapid expansion in location-based services. To access these services an application is typically installed in a user device. The application uses the device's GPS receiver to determine its location and allow the user to interact with merchants and other users in the same location.

In some existing applications users can leave reviews and comments regarding their experience at a particular location. These reviews and comments can be marked with a flag on a map to indicate the location/establishment to which they relate.

In these existing systems the map can become littered with flags such that it becomes difficult for a user to navigate. This problem can be enhanced by the fact that many of the flags relate to old or irrelevant information. In these circumstances it can be difficult for a user to identify the most recent and important flags and the information they contain. It would be desirable to have a system and method that can display indicator flags on a digital map without causing the map to become congested by flags of little importance.

### SUMMARY OF THE INVENTION

According to an aspect of the present invention there is provided a computer system comprising: a display configured to display a map to a user; a selection tool with which a user can select a location on the map; and one or more processors configured to display an indicator on the map at the selected location, and to modify a first aspect of the appearance of the indicator in dependence on the time that has elapsed since the location on the map was selected.

In this way it is possible for a user to identify the age of any indicators displayed on the map, based on their appearance. This may be particularly useful so that a user can quickly identify the relevance of displayed indicators.

In one example, the computer system may be used to display indicators on a map, representing hotel reviews by users. By modifying a first aspect of the appearance of the indicators over time, after the indicators have been created, a user can easily see which reviews are the most recent. This may be useful because users may be more inclined to rely on recent reviews. The computer system can therefore display indicators that accurately reflect current real-time perceptions.

Preferably the selection tool is not confined to select predetermined locations corresponding to known landmarks. A user can select an arbitrary location for an indicator. Preferably the user can apply a category and/or a comment for each indicator. In the example above the category may relate to hotel reviews and the comment may include the detail of the user's review. The category and/or comment may become visible when an indicator is selected on the map.

The first aspect of the appearance of the indicator may be its opacity or prominence. In addition, the opacity or prominence of the indicator may decrease in dependence on the time that has elapsed since it was selected.

In one example, by modifying opacity the indicator can gradually fade from view over time. Old indicators can be deleted in this way so that it is possible to retain a map that only shows the most up to date views and comments from online users. This may be advantageous in the example context of a negative hotel review. In this example the relevant indicator will initially be visible on the map, but will gradually fade. This is desirable because the negative review may become less relevant over time, especially if the hotel's practices improve. By fading the prominence of the review over time it is possible to emphasise and retain only the most relevant information. In this way, out of date information may be less likely to affect current perceptions.

Opacity may be expressed as a percentage. In one arrangement an indicator may be displayed initially with opacity of 100%. The opacity may decrease linearly towards 0% over a predetermined time period, such as one day.

A minimum opacity value may be provided for all indicators. For example, the minimum opacity may be 10%. Indicators may disappear from view when their opacity has reduced to this figure.

In an alternative arrangement the first aspect of the appearance of the indicator may be at least one of color, shape and area. Any of these aspects(or any combination of aspects) may provide a simple visual indication of the age of any indicators.

Preferably the computer system comprises a reinforcement tool with which a user can endorse an indicator that is displayed on the map. The one or more processors are preferably configured to modify the first aspect of the appearance of the indicator in response to its endorsement. In this way the user may be able to select an indicator at its position on the map in order to demonstrate that they agree with its sentiments. The appearance of the indicator may be altered to show its resonance with another user. In particular, the reinforcement tool may be used to counter the modification of the indicator's appearance that occurs with the passage of time.

The reinforcement tool may include a device such as a mouse or a touch-screen with which a user can interact with the digital map. Preferably the user can select an indicator in order to see its full details and then click on a ‘like’ button in order to initiate the reinforcement tool.

The reinforcement tool can cause reinforced indicators to appear more prominently on the map. This is advantageous because multiply reinforced messages are more likely to represent a true reflection of the associated resource, whether this is a commercial venue or a shared sentiment about a particular location. The reinforcement tool can also encourage preferential attachment behaviour whereby a high level of reinforcement can encourage other users to reinforce the indicator.

The one or more processors may be configured to modify the first aspect of the appearance of the indicator by a predetermined amount in response to its selection. In this way, a step-change in the appearance of the indicator can occur each time it is selected.

Where the first aspect of the appearance of the indicator is its opacity, each selection of the indicator by the reinforcement tool may result in an increase in opacity by a fixed amount. For example, each selection by the reinforcement tool may result in an increase in opacity by an absolute amount, such as 10% on a 0-100% scale.

The one or more processors may be configured to increase the opacity of the indicator by a predetermined amount upon its selection by the reinforcement tool. In this way a user can make the indicator appear more prominent on the map through their recommendation. The most popular indicators on a map can therefore stand out with respect to the others.

The displayed map may include a plurality of indicators, and the one or more processors may be configured to modify a second aspect of the appearance of indicators that are separated by less than a predetermined amount on the display. The second aspect of the appearance of the indicators may be their shape, color or area. When color is selected it may be possible to show ‘hot’ zones on the map where there is intense user comment or activity.

The color of indicators may be indicative of their popularity. In one example closely separated indicators may be given a color in a spectral range to indicate the number of reinforcements performed by users. A blue-red spectral range may be used, for example, as a heat map so that the most popular groups of closely separated indicators can be identified easily.

The displayed map may include a plurality of indicators, and the one or more processors may be configured to merge indicators that are separated by less than a predetermined amount on the display. If two indicators are very close together on the display then it may be difficult for a user to distinguish them. In these circumstances it may be preferable to display a merged indicator. The color of the merged indicator may be selected to show that a merging step has occurred and there is a dense concentration of indicators. Preferably the merged indicator is given a color in a spectral range to indicate the combined popularity of the constituent indicators, based partially on the number of reinforcement events they have received.

The computer system may include a positioning device for providing a location to the selection tool. In this way the positioning device can provided a suggested location to the selection tool. The user can then select their current location and an indicator can be marked on the map at that location. The user may also be able to over-ride the position provided by the positioning device and the selection tool may include a device such as a mouse or a touch-screen with which a user can select a location on the map.

In one example the positioning device may be a GPS receiver. However, a wide variety of alternative positioning devices could be used, as would be apparent to a skilled person.

The one or more processors may be configured to generate an alert when the position determined by the positioning device is within a predetermined range of an indicator. In this way the computer system may be arranged to alert a user when they are near to an indicator that may be of interest to them. Preferably an alert is generated only when the relevant indicator is in a category that the user has selected to be of interest. In one example, the user may be interested in museums. Thus, whenever the positioning device determines that it is within a predetermined range of a museum the user may receive an alert notification.

The one or more processors may be configured to create a list of the plurality of indicators. Preferably the list is ranked in terms of the order of the strength of the first aspect of the displayed indicator. This may be considered to equate to current user popularity. The list may be displayed on the display in addition, or as an alternative, to the map.

The present methods may be used to drive calls to action addressed to third parties; this may be referred to as the “make-something-happen-around-you” effect. For example a local group may decide to generate an indicator with a high opacity, pertaining to an issue of current concern. The high opacity signal may be strong and resilient enough to be noticed by third parties who are willing and able to address and rectify the issue.

The present methods may also be useful in coordinating complex, large scale operations without requiring a centralized chain of commands. Running and maintenance of infrastructure during large festivals, for example, could become distributed and self-organising. Festival goers may be able to create indicators regarding a real-time sentiment, and the organiser's agents may be able to respond to the user feedback without supervisory orders.

Aspects of the computer device may be provided on a client device such as a tablet computer or a cellular telephone. Other aspects of the computer device may be provided on a server device which is in communication with the client device.

According to another aspect of the present invention there is provided a client and server device in a network comprising: a client device comprising: a display configured to display a map to a user; and a selection tool with which a user can select a location on the map; a server device comprising: an input module configured to receive an input from the selection tool concerning the selected location; one or more processors configured to instruct the client device to display an indicator on the map at the selected location, and wherein the one or more processors are configured to modify a first aspect of the appearance of the indicator in dependence on the time that has elapsed since the location on the map was selected.

According to another aspect of the present invention there is provided a server device comprising: a storage device configured to store a digital map; an input module configured to receive a user input regarding a selected location on the map; one or more processors configured to output an indicator for display on the map at the selected location, and to output instructions to modify a first aspect of the appearance of the indicator in dependence on the time that has elapsed since the location on the map was selected.

According to yet another aspect of the present invention there is provided a client device comprising: a display configured to display a map to a user; a positioning device for determining the position of the client device; a selection tool with which a user can mark a location, as determined by the positioning device, on the map; a transmitter configured to transmit the selected location to a server; a receiver arranged to receive an instruction to modify a first aspect of the appearance of the indicator in dependence on the time that has elapsed since the location on the map was selected.

According to another aspect of the invention there is provided a method of labelling a digital map, comprising the steps of: selecting a location on the map; displaying an indicator on the map at the selected location; modifying a first aspect of the appearance of the indicator in dependence on the time that has elapsed since the location on the map was selected.

According to yet another aspect of the present invention there is provided a computer readable storage medium having a computer program stored thereon, the computer program comprising: a program module configured to receive a user input and select a location on a digital map; a program module configured to display an indicator on the map at the selected location; and a program module configured to modify a first aspect of the appearance of the indicator in dependence on the time that has elapsed since the location on the map was selected.

According to yet another aspect of the present invention there is provided a computer system comprising: a display configured to display a map to a user together with one or more indicators placed at locations on the map; a reinforcement tool with which a user can endorse an indicator that is displayed on the map; and one or more processors configured to modify at least a first aspect of the appearance of the indicator in dependence on the number of endorsements received.

In this way, a user can easily see which indicators are most popular on the map. In one configuration the indicators that have received the highest number of (positive and/or negative) endorsements may be demonstrated with one or more of color, prominence, opacity, shape or area of indicator.

Preferably the one or more processors are configured to modify the first aspect of the appearance of the indicator according to the number of endorsements received within a predetermined time period. Thus, the indicator may be displayed on the map based only on the most recent endorsements.

The predetermined time period may be proportional to the number of endorsements received. In one example, a first indicator on a map may receive a single endorsement soon after its creation, and a second indicator may receive four endorsements. Preferably the second indicator is displayed more prominently than the first indicator, to indicate the higher number of endorsements. Equally, the second indicator is preferably displayed on the map for longer. The relevant time period may be calculated according to a decay function.

According to yet another aspect of the invention there is provided a computer system comprising: a positioning device for providing a location; and one or more processors configured to generate an alert when the position determined by the positioning device is within a predetermined range of a location of interest.

In this way, the user may receive an alert when they are close to a particular location in which they have declared an interest. The alert may be generated whether or not the user is actually looking at a map on a display, based only on a comparison between the user's current coordinates, and the co-ordinates of the location of interest. Several locations of interest may apply at any one time, and their co-ordinates may be stored at a data storage unit in either a client or server device.

The predetermined range may be set according to the application in question. For some applications the predetermined range may be 1 mile, whereas for other applications the predetermined range may be 20 meters or less.

Apparatus features may be provided as corresponding method features and vice-versa.

### BRIEF DESCRIPTION OF THE DRAWINGS

Embodiments of the present invention will now be described, by way of example only, with reference to the accompanying drawings in which:

FIG. 1 is a schematic view of a client and server device in a network in an embodiment of the present invention;

FIG. 2 is a schematic view of the components in a client device in an embodiment of the present invention;

FIG. 3 is a schematic view of the components in a server device in an embodiment of the present invention;

FIG. 4 is a flow diagram showing a sequence of steps that can be performed in a an embodiment of the present invention;

FIG. 5 is a screenshot showing indicator flags overlaid on a map in an embodiment of the invention; and

FIG. 6 is another screenshot showing indicator flags overlaid on a map in an embodiment of the invention.

### DETAILED DESCRIPTION OF THE INVENTION

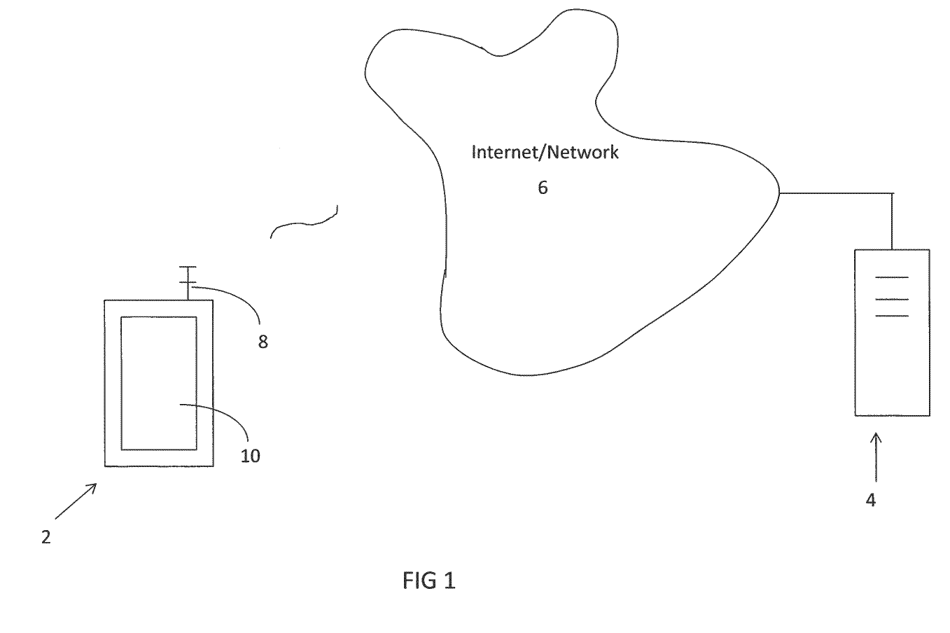

FIG. 1 is a schematic view of a client device 2 and a server computer 4 in communication over a network 6 such as the internet. The client device 2 includes an aerial 8 for use in transmitting and receiving data over the network 6. The client device 2 also includes a touch-screen 10 that can be used both for displaying a map to a user and for receiving user input.

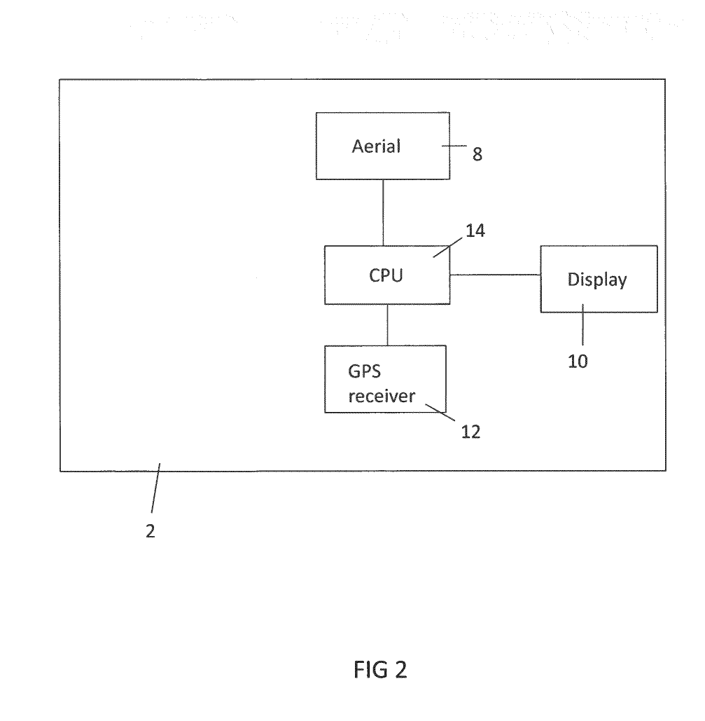

Further detail of the client device 2 is provided in FIG. 2. The client device 2 includes a GPS receiver 12 and a central processing unit (CPU) 14. The CPU 14 sends and receives data from both the touch-screen 10 and the aerial 8. The client device 2 may be provided as a cellular telephone, a tablet computer, a personal computer, or a personal digital assistant (PDA), for example.

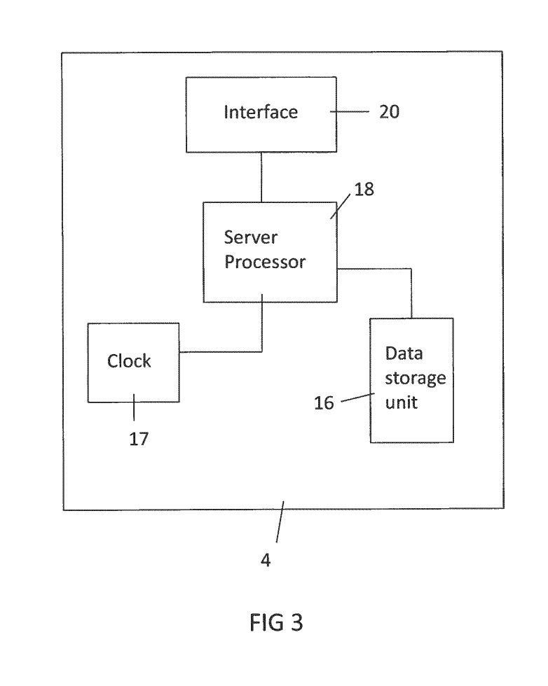

Further detail of the server computer 4 is provided in FIG. 3. The server computer 4 comprises a data storage unit 16, a clock 17, and a server processor 18. An interface 20 is also provided so that the server computer can send and receive data to/from the network 6.

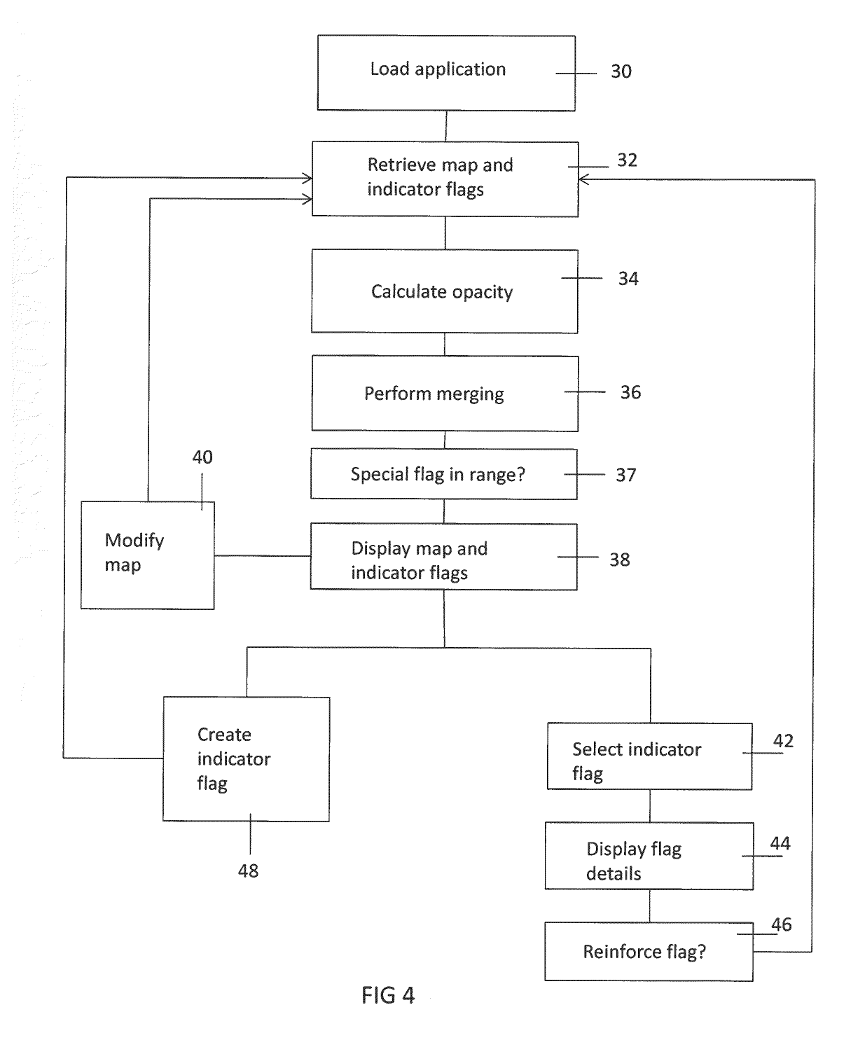

The operation of the client device 2 and the server computer 4 may be understood more readily with reference to FIG. 4 which shows a flow diagram with a sequence of steps that may be undertaken. In step 30 the application is loaded in the client device 2, ready for use. The CPU 14 obtains the user's current location, as well as the current time, from the GPS receiver 12 and submits a request for a digital map, centred on the current location, to the server 4 over the network 6.

In step 32 the server processor 18 receives the user's request and retrieves the relevant map data from the data storage unit 16. The processor 18 also retrieves details of any user-generated indicators for the requested map area. These user-generated indicators have been created by individual users and they are stored in the data storage unit 16.

At step 34 the server processor 18 calculates opacity for the indicator flags to be overlaid on the map. In one embodiment, the opacity of a flag can be calculated with equation (1):

$$O ( n ) = 100 * \frac{( 1440 - {t}_{n} )}{1440} + 10 N * ( 1 - \frac{O ( n - 1 )}{100} ) \qquad ( 1 )$$

where:

O(n) is opacity at time n minutes since the indicator flag was created, and O=100% when n=0;

tₙ is the time (in minutes) that has elapsed since the indicator flag was created; and

n is the number of users that have chosen to reinforce the indicator flag.

Opacity is expressed as a percentage and the only valid values are in the range 10≦O≦100. In equation (1), the minimum valid opacity is 10%. An indicator flag is not displayed if its opacity drops below this value because it is considered too faint.

Using equation (1) above the server processor 18 determines a value of opacity for each indicator flag based on the difference between the current time, as measured by the clock 17, and the time at which the indicator flag was created. A linear decay function is provided so that the indicator flag has maximum opacity at the time of creation, and the opacity is gradually reduced towards zero.

Equation (1) also includes a contribution based on user feedback to the indicator flag. Specifically, a user can select an indicator flag to indicate their agreement with the message. The opacity for relevant the indicator can be increased in dependence on the number of users that have made this indication. Thus, users can choose to re-inforce the opacity of a particular indicator. The data storage unit 16 in the server 4 retains a record of each incidence of a user deciding to reinforce a particular indicator flag, and this information is used in the decay algorithm.

Equation (1) includes a saturation term such that the effect of a user's reinforcement is greater when the opacity is low. Thus, the opacity of an indicator will not be significantly affected if it receives a large number of reinforcements soon after it was created. However, the indicator will continue to have a high opacity for an extended period, whereas it would fade if had not received any reinforcements.

Indicator flags can be overlaid on the map. This can be achieved by structuring the display so that indicator flags are in a higher plane than the digital map. In this way, the map can be viewed through any indicator flags that have opacity values less than 100%.

At step 36 the server processor 18 analyses the separation of indicator flags that are due to be displayed on the client device 2. If two or more indicator flags have a separation at the relevant scale that is less than a predetermined value then the server processor 18 begins a merging procedure. Individual indicator flags selected for merging are replaced by a merged indicator. The merged indicator has a different color and shape to the individual indicator flags to show that merging has occurred. By using a different color it is possible to create “hot zones” on the map to indicate regions in which there is a dense concentration of indicator flags. The color can be selected from a spectral range to represent a combined score for the opacity values of the merged indicators. A red-blue spectrum may be chosen so that blue values represent merged indicators with a low combined opacity score, whereas red values represent merged indicators with a high combined opacity score.

At step 37 the CPU 14 assesses whether the user's current location, as determined by the GPS receiver 12 is within a predetermined range of a particular category of indicator flag. For example, the user may have indicated that they are interested in indicator flags in which soccer clubs advertise that they are looking for players. At step 37, if the user's current location is within one mile of such an indicator flag an alert is generated and displayed to the user on the display 10. In another configuration the alert may be a sound or vibration. In this way the user can receive the alert whether or not they are viewing the display 10.

At step 38 the server 4 sends the map data and information on any flag indicators and merged indicators to the client device 2 over the network 6. The client device 2 receives these data from the server 4 and displays the map on the touch-screen display 10. If the user decides to zoom in, zoom out, or pan the map then, at step 40, a new request is generated and sent to the server 4 so that the relevant map data can be retrieved.

At step 42 a user can select a flag indicator, as displayed on the map by using the touch-screen display 10. When a flag indicator is selected further details are revealed on the display 10 at step 44, including full details of the user's comments. At step 46 the user can decide to reinforce a flag indicator, for example if they particularly agree with the comments. If a user does decide to reinforce a flag indicator then the CPU 14 reports this to the server 4. The data storage unit 16 of the server 4 stores a record of each incidence of reinforcement of a marker, and this information is used by the server processor 18 when it calculates opacity using equation (1) above. Thus, a user's decision to reinforce a particular flag can cause the flag to be displayed on the map with a higher opacity.

At step 48 a user can decide to create an indicator flag. To create an indicator flag the CPU 14 obtains the user's current location, as well as the current time, from the GPS receiver 12. In this example the user is free to create an indicator flag at an arbitrary geographic location of their choice. The user is prompted to enter details for the chosen location. Typically the user is prompted to choose a category for the indicator flag, a title, and a review.

At step 48 the data entered at the client device 2 using the touch-screen 10 are uploaded by the CPU 14 to the server 4 so that they can be stored in the data storage unit 16. Once these data have been uploaded the map and the relevant indicator flags can be retrieved from the server 4 so that the user can see their indicator flag displayed on the map.

The user may decide to inspect the indicator flags for a particular map area as a list, rather than on the map. By selecting this option the client device 2 can display a list of the relevant indicators on the display 10, ranked according to one of their properties, such as their proximity to the user's current location.

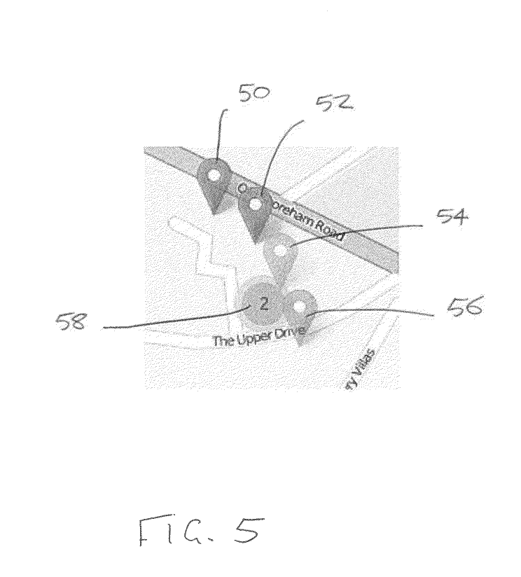

FIG. 5 is a screenshot showing indicator flags overlaid on a map, as it would appear on the touch-screen display 10 of the client device 2. Four individual indicator flags 50, 52, 54, 56 are shown overlaid on the map. A merged indicator flag 58 is also displayed. In this example a first group of indicator flags 50, 52 are displayed with a high opacity, indicating either that they were created recently and/or that they have received a number of reinforcements from individual users. A second group of indicator flags 54, 56 are displayed with a comparatively low opacity, indicating that they were created comparatively long ago and that they have not received many reinforcements. A user can therefore appreciated quickly that the first group of indicator flags 50, 52 is more likely to contain more popular and relevant information. The second group of indicator flags 54, 56 is still available for selection, however because their opacity, as calculated by equation (1), is greater than 10%.

The merged indicator flag 58 is provided with a different shape to show that it represents more than one individual indicator flag. In addition, a numeral is displayed in the centre of the merged indicator flag 58 to show the number of flags that have been merged (in this case two). The color of the merged indicator flag 58 is chosen from a spectral range to represent the cumulated opacity values of the merged indicator flags.

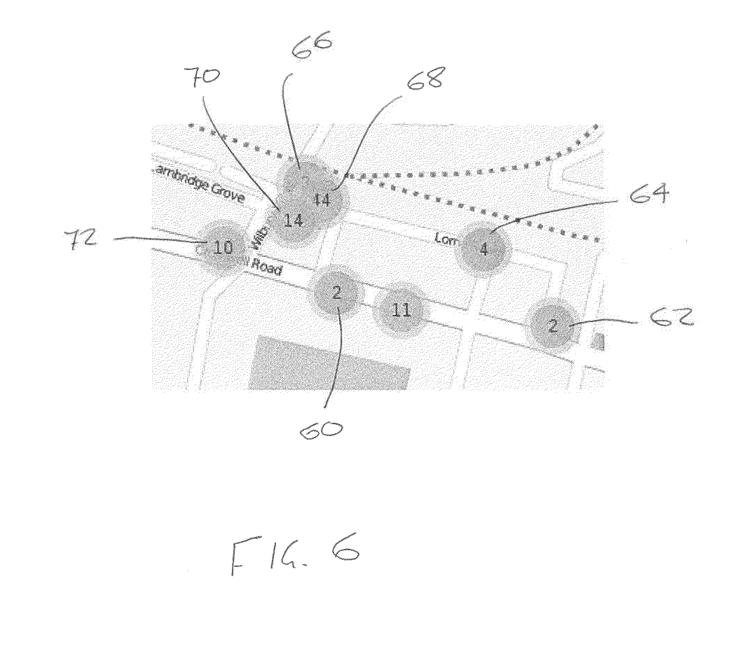

FIG. 6 is another screenshot showing indicator flags overlaid on a map. In this example there are a number of merged indicator flags. Each merged indicator flag has a central numeral to specify how many indicator flags have been merged. In this example the merged indicator flags can either appear yellow or green, for example, depending on the cumulated opacity values of the merged indicator flags. A first group of merged indicator flags 60, 62, 64, 66 are marked in yellow, for example, and a second group of merged indicator flags 68, 70, 72 are marked in green, for example.

I claim:

1. A computer system comprising:
a display configured to display a map to a user;
a selection tool with which a user can select a location on the map; and
one or more processors configured to display an indicator on the map at the selected location, and to modify a first aspect of the appearance of the indicator in dependence on the time that has elapsed since the location on the map was selected.

2. The computer system of claim 1 wherein the first aspect of the appearance of the indicator is its prominence.

3. The computer system of claim 1 wherein the first aspect of the appearance of the indicator is its opacity, and the opacity decreases in dependence on the time that has elapsed since the location on the map was selected.

4. The computer system of claim 1 wherein the first aspect of the appearance of the indicator is at least one of color, shape and area.

5. The computer system of claim 1 further comprising a reinforcement tool with which a user can endorse an indicator that is displayed on the map, wherein the one or more processors are configured to modify the first aspect of the appearance of the indicator when it is endorsed.

6. The computer system of claim 4 wherein the one or more processors are configured to modify the first aspect of the appearance of the indicator by a predetermined amount in response to its endorsement.

7. The computer system of claim 6 wherein the first aspect of the appearance of the indicator is its prominence, and the one or more processors are configured to increase the prominence of the indicator by a predetermined amount upon its endorsement by the reinforcement tool.

8. The computer system of claim 1 wherein the displayed map includes a plurality of indicators, and wherein the one or more processors are configured to modify a second aspect of the appearance of indicators that are separated by less than a predetermined amount on the display.

9. The computer system of claim 9 wherein the second aspect of the appearance of the indicators is indicative of their popularity.

10. The computer system of claim 10 wherein the second aspect of the appearance of the indicators pertains to one at least one of their shape, size and color.

11. The computer system of claim 1 wherein the displayed map includes a plurality of indicators, and wherein the one or more processors are configured to merge indicators that are separated by less than a predetermined amount on the display.

12. The computer system of claim 1 further comprising a positioning device for providing a location to the selection tool.

13. The computer system of claim 12 wherein the one or more processors are configured to generate an alert when the position determined by the positioning device is within a predetermined range of an indicator.

14. The computer system of claim 1 wherein the displayed map includes a plurality of indicators, and wherein the one or more processors are configured to create a ranked list of the plurality of indicators.

15. A server device comprising:
a storage device configured to store a digital map;
an input module configured to receive a user input regarding a selected location on the map;
one or more processors configured to output an indicator for display on the map at the selected location, and to output instructions to modify a first aspect of the appearance of the indicator in dependence on the time that has elapsed since the location on the map was selected.

16. A client device comprising:
a display configured to display a map to a user;
a positioning device for determining the position of the client device;
a selection tool with which a user can mark a location, as determined by the positioning device, on the map;
a transmitter configured to transmit the selected location to a server;
a receiver arranged to receive an instruction to modify a first aspect of the appearance of the indicator in dependence on the time that has elapsed since the location on the map was selected.

17. A method of labelling a digital map, comprising the steps of:
selecting a location on the map;
displaying an indicator on the map at the selected location;
modifying a first aspect of the appearance of the indicator in dependence on the time that has elapsed since the location on the map was selected.

18. A computer readable storage medium having a computer program stored thereon, the computer program comprising:
a program module configured to receive a user input and select a location on a digital map;
a program module configured to display an indicator on the map at the selected location; and
a program module configured to modify a first aspect of the appearance of the indicator in dependence on the time that has elapsed since the location on the map was selected.

19. A computer system comprising:
a display configured to display a map to a user together with one or more indicators placed at locations on the map;
a reinforcement tool with which a user can endorse an indicator that is displayed on the map; and
one or more processors configured to modify the first aspect of the appearance of the indicator in dependence on the number of endorsements received.

20. The computer system of claim 19 wherein the one or more processors are configured to modify the first aspect of the appearance of the indicator according to the number of endorsements received within a time period.

21. The computer system of claim 20 wherein the time period is proportional to the number of endorsements received.

22. The computer system of claim 19 wherein the first aspect of the appearance of the indicator is at least one of color, shape, prominence, opacity and area.

23. A computer system comprising:
a positioning device for providing a location; and
one or more processors configured to generate an alert when the position determined by the positioning device is within a predetermined range of a location of interest.
